(19) United States
(12) Patent Application Publication
(10) Pub. No.: US 2005/0061977 A1
(43) Pub. Date: Mar. 24, 2005

(54) Radiation sensor with electro-thermal gain

(76) Inventor: William N. Carr, Montclair, NJ (US)

Correspondence Address: William N. Carr, 251 South Mountain Ave., Montclair, NJ, 07040, US

(21) Appl. No.: 10/669,029

(22) Filed: Sep. 24, 2003

(51) Int. Cl. G01J 1/42; G01J 5/00

(52) U.S. Cl. 250/338.1; 250/372

(57) ABSTRACT

A thermal sensor or sensor array for detecting including imaging of low level radiation. The sensor utilizes a thin film of pyro-optical material to modulate the reflectivity and/or transmission of a photonic carrier beam. The photonic carrier beam is modulated by the temperature of the pyro-optical film and detected by typically a silicon detector. A slight increase in the temperature of the pyro-optical film due to absorbed low level radiation causes a corresponding change in the electrical resistance of heaters within each pixel of the thermal sensor array. An external fixed amplitude voltage or current source provides power to increase the temperature of the pyro-optical film beyond the heating caused by the absorption of low level radiation alone. This thermal amplification effect provides a radiation sensor with electro-thermal signal gain.

### FIELD OF THE INVENTION

This invention relates to microsensors that are constructed utilizing semiconductor fabrication processes and, more particularly, to a thermal radiation sensor. The sensor us useful for detecting low level radiation absorbed in microstructures at power levels of a nanoWatt and less into microstructures. This invention is typically used for the detection of low level infrared radiation. However, the low level radiation may be comprised of any electromagnetic radiation absorbed into a pyro-optical film within the radiation sensor and thus may include wavelengths ranging from the ultraviolet, visible, near infrared, far infrared, and into the millimeter wave regions. The present invention can be devised as a single sensor element or as an array of pixels including a focal plane array.

### BACKGROUND OF THE INVENTION

There are many types of infrared or low level radiation sensors for imaging and non-imaging applications. The most widely used infrared imagers employ photon detection and thermal detection. Most thermal detectors utilize sensor elements including thermistors, piezoelectric, and ferroelectric elements that change electrical characteristics with temperature. In each of these sensor types there is a direct electrical connection between the sensor element and the readout electronics or readout integrated circuit ROIC. A limitation in this type of radiation sensor is that the direct electrical connection mentioned serves as a pick-up for parasitic noise sources due to capacitive, inductive, and electromagnetic pick-up of unwanted signal levels. The present invention has no electrical connection between the sensor structures for low level radiation and the readout ROIC and thus avoids many of the aforementioned parasitic noise problems.

Micromachining has been developed as a means for accurately fabricating small structures and is now being applied to microstructures for radiation sensors. Such processing involves the selective etching of a substrate and the deposition thereon of layers of thin films. Various sacrificial layers are employed to enable the fabrication of relatively complex interactive structures. This technology is generally referred to as MOEMS (micro-optical electromechanical systems) technology and is utilized in a wide range of application devices. In the present invention we utilize MOEMS technology to fabricate microplatforms that contain a pyro-optical film as a key component of a radiation sensor system. These microplatforms are a key component within the radiation sensor system which includes a high level source of photonic radiation and a detector for the modulated high level photonic beam. The pyro-optical film modulates the amplitude of the photonic carrier beam to the detector. Thus, the photonic carrier beam may also be referred to as the interrogation beam. The high level photonic radiation is typically a visible or near infrared wavelength beam. The photon detector is typically a two-dimensional array of silicon charge coupled diodes (CCD) or CMOS silicon diodes. When low level radiation is incident on a pyro-optical thin film, an incremental heating occurs which in turn causes a change in the transmissivity or reflectivity of the interrogation carrier beam. This change in the pyro-optical characteristics modulates the amplitude of a photonic beam exiting to an ROIC detector. In the present invention the resulting video signal output from the ROIC and associated circuitry is highly sensitive to the amplitude of incident low level radiation.

A thermal imager that includes an infrared sensitive light valve and a light source arranged to illuminate the valve was described by Elliott and Watton in U.S. Pat. No. 4,594,507. This imager contains an infrared sensitive optically active liquid crystal cell and an analyzer adjusted to near extinction. An optical processor comprising a lens and an apodized stop filter lies in the light path between the valve and the detector array. The thermal imager described in this patent uses an interrogation light beam but does not mention microplatforms, microstructures, or thermal gain.

An infrared sensor scheme is described and without thermal gain by Hanson in U.S. Pat. No. 5,512,748 in which an infrared sensitive film is used to amplitude modulate a photonic carrier beam. This patent describes a focal plane array including a plurality of thermal sensors mounted on a substrate. An image is formed on an infrared sensitive film layer in response to infrared radiation from a scene. Electromagnetic radiation from a source is used to reproduce or transfer the image from the thermal sensors onto the first surface of the substrate. In the Hanson patent there is no mention made of a pyro-optical film in which the absorption of a visible or near infrared carrier beam increases with temperature to achieve a photo-thermal gain.

Cross et al in U.S. Pat. No. 4,994,672 describe an infrared imaging system which includes a pyro-optic sensor for receiving a low level thermal image on one of its sides, the sensor exhibiting a substantial change in refractive index in response to changes in its temperature. A high level light beam is projected onto the sensor and locally reflected in accordance with local changes in the refractive index of a pyro-optic film. This detector and imager description does not mention any structures or techniques for obtaining thermal gain.

Grossman and Reintsema in U.S. Pat. No. 6,323,486 B1 describe a bolometer in which the vanadium oxide sensor film is heated from a current source to achieve a negative electrothermal feedback with electrical readout. This teaching does not mention using vanadium oxide or other film to modulate a photonic light beam and the use of a CCD readout. The use of a positive feedback factor to enhance the responsivity is not mentioned.

Blodgett et al in U.S. Pat. No. 5,608,568 describre using a thin film of vanadium oxide as a spatial light; modulator in which the thermally isolated thin film of vanadium oxide is electrically heated to proviide a bistable reflection of incident, optical radiation. Micromachined, thermally isolated platforms are not mentioned. This teaching does not describe a feature sensitive to low level incident radiation.

It is an object of this invention to provide an improved radiation sensor wherein micromachining of a thermally isolated platform is used with selected pyro-optical thin films to accomplish a sensor with thermal gain. This means of thermal gain is powered by the high level carrier beam.

It is another object of this invention to provide a pyro-optical sensor with an increased sensitivity to low level radiation wherein the readout noise and photonic noise contributions to the system output are relatively reduced. The result is a decrease in the net equivalent temperature differential NETD of a source of low level radiation that can be detected by the radiation sensor.

### SUMMARY OF THE INVENTION

In the present invention we describe a radiation sensor for low level radiation where typically less than a nanoWatt is absorbed in a pyro-optical microstructure. The radiation sensor contains an absorbing microplatform that is thermally isolated from a substrate, a high level interrogating carrier beam and source, and a sensitive detector for the carrier beam exiting the microplatform. The carrier beam is modulated by the pyro-optical thin film in the microplatform and detected by the ROIC. The microplatform contains an integral pyro-optical film which modulates the high level photonic carrier source in addition to and an electrical heater element. The low level radiation to be sensed is partially absorbed on the microplatform causing a first incremental increase in temperature. The intensity of the photonic carrier beam exiting the microplatform is amplitude modulated by the temperature of the pyro-optical film.

The microplatform contains the integral pyro-optical film and the heater element where (1) a first source of low level radiation or heat is incident upon the sensor platform and partially absorbed causing a first incremental heating of said film, (2) a power source of constant voltage or constant current driving the resistive heater element with a thermal coefficient of resistance thereby causing a further incremental heating of the microplatform, and where the combined temperature rise of the pyro-optical film due to both the first and second incremental temperature increases is greater than that due to the first source of radiation alone, and (3) used with an optical carrier beam for readout by a photonic CCD or CMOS readout ROIC. The structure with cooperating sensing and heating structures comprise a sensitive sensor for low level radiation, with an internal photonic carrier beam for interrogating the temperature of the pyro-optical film.

The resistor heater establishes a quiescent temperature level T_{Q} or Tₒₒ for the microplatform which is several degrees above the heat sink temperature of the underlying substrate. Typically the first incremental heating is on the order of microdegrees to millidegrees Centigrade. The first incremental heating level ΔTᵢᵣ causes a further increase in the electrical power dissipated from the heater element in the microplatform due to it's thermal coefficient of resistivity. The amplitude of the second incremental heating is ultimately limited by the nonlinearity of the thermal hysteresis of the pyro-optical film. The enhanced heating of the microplatform in excess of that obtained from the low level radiation alone is a stable gain maintained around the quiescent temperature operating point T_{Q}.

The electro-thermal gain of the present invention can be described further by examining the basic theory of optical absorption in the microplatform. FIG. 1 shows the two incident radiation beams and the and the exiting high level or carrier beam with the pyro-optical film 100. Symbols used are defined for amplitude of the incident low level radiation Φᵢᵣ, amplitude of incident carrier beam Φ_{ci}, and amplitude of exiting carrier beam Φ_{co}. The amplitude Φ_{co} is modulated by the temperature of the microplatform; in this example the transmission amplitude is modulated.

Typical hysteresis 200 of a pyro-optical thin film such as vanadium oxide as a function of temperature is shown in FIG. 2. The vertical axis is the reflectance or transmission transfer function for the high level beam Φ_{co}. The exiting carrier amplitude Φ_{co} corresponding to the quiescent temperature is defined as Φₒₒ. A pyro-optical film heated from a low temperature value reaches a quiescent temperature of Φₒₒ in a situation without incident beams Φ_{ci} and Φᵢᵣ due to the heater power V²/Rₒ where the voltage V is impressed across the heater of quiescent resistance Rₒ. The low level incident beam Φᵢᵣ is absorbed in the pyro-optical film 100. For the situation without any change in Rₒ the temperature of the film increases by the increment ΔTᵢᵣ. The total increase T in temperature above heat sink temperature due to both the low level incident heating and the electrical heater element is:
ΔT=ΔT_{iρ}+ΔT_{elec}
The temperature increase is due to the electrical power V²/R and inversely proportional to the thermal conductivity G of the microplatform tether beams.
ΔT_{elec}=Vₒ²/GR
The resistance R of the heater element is the quiescent resistance R_{Q} reduced by the first incremental heating.
R═R_{Q}−ΔR_{iρ}
The heater element change of resistance ΔR_{iρ} due to the first increment of heating is:
ΔR_{iρ}=k_{iρ}ΔT_{iρ}
The quiescent temperature T_{Q} of the heater is determined by the quiescent resistance R_{Q}
T_{Q=V}ₒ²/G R_{Q}
From the above relationships, the final microplatform temperature T
T−T_{Q}=ΔT=(1+kᵢᵣVₒ²/R)ΔTᵢᵣ
where ΔT>>ΔTᵢᵣ.
The ratio of the final increase in temperature ΔT to the first incremental heating ΔTᵢᵣ is the electro-thermal gain factor G_{et:}
Gₑₜ=1+kᵢᵣVₒ/R

### BRIEF DESCRIPTION OF THE DRAWINGS

FIG. 1 First and second sources incident on a film of pyro-optical material

FIG. 2 Example of a typical pyro-optical hysteresis with parameters defined

FIG. 3 is a schematic view of a radiation sensor system providing thermal gain with transmission of the second source of radiation through the MEMS plane

FIG. 4 is a schematic view of a radiation sensor system providing thermal gain with reflection of the second source of radiation from the MEMS plane

FIG. 5 is a schematic side view of a transmission-type microplatform pixel containing a pyro-optical film with electro-thermal gain

FIG. 6 is a schematic side view of a reflecting-type microplatform pixel containing a pyro-optical film with electro-thermal gain

FIG. 7 is a schematic top view of a 2×2 array of microplatforms, in which the vanadium oxide serves as both the pyro-optical modulating film and also as the resistive heater element with a negative temperature coefficient of resistance TCR

### DETAILED DESCRIPTION OF THE INVENTION

We describe a radiation sensor which contains an internal photonic carrier beam to monitor extremely small variations in the temperature of a microplatform. The reflection or transmission of the exiting photonic carrier beam with respect to a microplatform is monitored by a detector. The present invention uses micro-opto-electromechanical-systems MOEMS technology to form a single microplatform or an array of microplatforms for detecting low level radiation. Each microplatform contains a resistive heater with a high temperature coefficient of resistance. Each resistive heater is driven by a current or voltage source as appropriate to cause the microplatform to heat with the absorption of low level incident radiation.

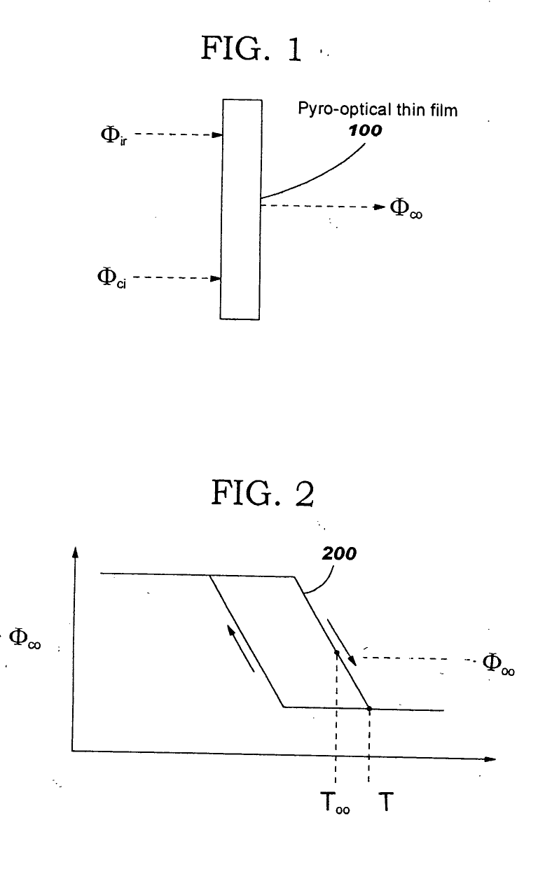

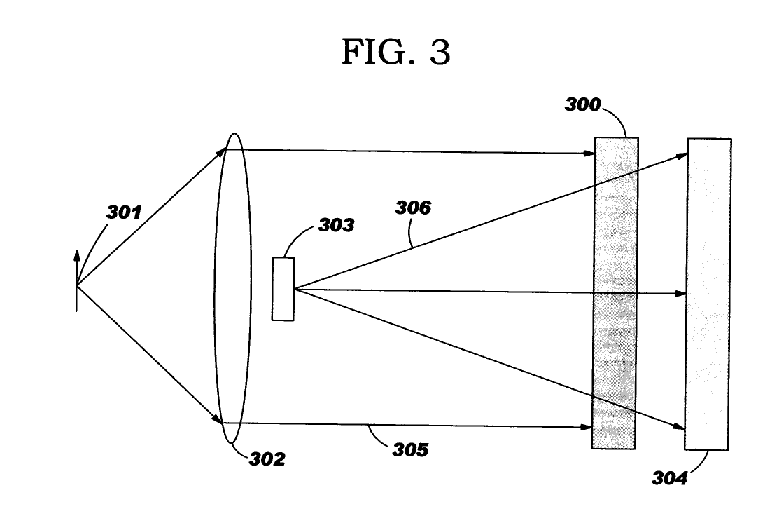

FIG. 1 is a block diagram of a radiation sensor constructed in accordance with the present invention. During operation for the application of thermal radiation detection, emission from scene 301 is received by collection optics 302 and focused on the microplatform 300. In many cases a chopper is placed in the beam of low level radiation 305 between the optics 302 and the microplatform 300 thereby enabling a synchronized detection function. Source 301 may be any source of low level radiation that can be focused onto and absorbed into the microplatform. The low level radiation beam 305 is absorbed in the microplatform 300 causing an incremental increase in the temperature of the microplatform 300. In a typical application the source 301 is a scene of objects that emit thermal radiation and the microplatform structure 300 consists of an array which provide means of imaging through the sensor system of FIG. 3. In the case of imaging, the two-dimensional source 301 is transferred as a scene to the microplatform with an incremental temperature heated pattern on the microplatform array corresponding to the scene 301. As with all thermal imaging systems, the invention is especially useful when imaging by means of visual wavelengths is unavailable, such as in the dark or when vision is impaired by smoke, dust, or other particles. The optics 302 are well known in the art of thermal imaging and may be any one of a number of systems of lenses. Optics 302 focus the source 301 on the microplatform 300 in order to sense the radiance of the incident infrared radiation 305 it receives. Collection optics 302 may include one or more lenses made of material that transmits infrared radiation such as germanium. The placement of optics 302 and optional chopper with respect to the microplatform 300 is accomplished using well known principles of optical design as applied to thermal imaging systems. The low level radiation may alternatively be focused onto the microplatform 300 using Cassegrainian reflective optics. Nonthermal sources of low level radiation such as photonic bursts of energy of visible or ultraviolet radiation can be focused onto the microplatform 300 also by transmissive or reflective collection optics. Low level radiation from millimeter/microwave sources can be directed or focused onto the microplatform by structures including directional antennas and reflectors effective at these very long wavelengths compared to infrared.

An array of microplatforms 300 may be used as part of a wide variety of low level radiation detectors and thermal imaging systems. The invention may be used with either “staring” or “scanning” detection means. A staring detector is a large area detector onto which the entire thermal image is focused at once and read out electronically. A scanning detector uses a mirror or tethered means to sweep the low level radiation across the microplatform array. Usually, although not necessary for the invention, both types of detection means consist of a plurality of sensor elements, with the output of each thermal sensor representing a portion of the viewed scene. For example, the output of each microplatform 300 may represent a single pixel of the total image. Thermal sensors described in FIG. 3 incorporating the present invention may be particularly beneficial for use in high density arrays 300 and with high density visual displays.

High level light source 303 is provided for use in transferring the low level radiation spot or pattern formed on the microplatform or microplatforms 300 to photosensors 304 disposed in the path of the high level radiation beam 306 from source 303 as illustrated in FIG. 3. Photosensor 304 detects the beam 306 after it is modulated by the transmission through the microplatform. The photosensor 304 can be an array for the case of imaging in conjunction with an array of microplatforms 300. For many applications, optical source 303 preferably provides electromagnetic radiation in the visible or near infrared spectrum to match the sensitivity spectrum of silicon used in the photodetector 304. The use of the high level beam 306 from source 303 to transfer spots or images from low level sources to photosensor 304 results in a conversion of the thermal temperature increment in microplatform 300 into modulation of the high level carrier beam detected by the photodetector 304.

Electronics are used to format the electrical signal output in photodetector 304. Electronics are provided to perform selected operations on the photodetector output including digitization, synchronizing with the chopper, zooming, general image processing, formatting for a display with techniques well known to the art of imaging and low level signal processing. The large signal level of the detected high level beam 306 contains a small signal modulation due to the low level beam 305. Image processing within or in cascade with the photodetector 304 is used to eliminate the large signal component from 306 to provide an unbiased output representative of the intensity pattern of the low level incident beam 305. For the display application embodiment, a special viewing device such as a CRT or LCD display is driven by the electronics. The image on a display obtained through the electronics from the radiation sensor system is typically a visual representation of the radiance image of the microplatform 300 corresponding to points on the two dimensional scene 301. The radiation sensor system may include digitization electronics so that the signals can be stored and processed as digital data. This requires sampling, storage, image subtraction and processing circuits which are well known in the field of video and graphics processing and be included as part of the electronics. The radiation sensor system may function as a radiometer to provide temperature measurements of radiant energy sources present in source 301 or other sources focused onto the microplatform 300.

A chopper wheel or other optical switching device is generally used to synchronously interrupt the beam of low level radiation 305 to the microplatform 300 thereby providing a reference signal and a bias signal. Collection optics 302 and the chopper cooperate to form a reference temperature increment on the microplatform 300 corresponding to the background radiance. The electromagnetic energy 306 from light source 303 in cooperation with photosensor 304 will produce a signal corresponding to the total radiance filtered by the chopper from source 301 during any frame of time. Electronics included in the photodetector 304 and associated electronic processing will cooperate with each other to process the bias signal and the reference signal to generate an unbiased signal which may be transformed into a data stream for display or storage in a memory for later processing. The process of establishing a reference signal and receiving a bias signal is repeated in succession for a stream of video images in the case of imaging. The present invention contemplates either establishing a reference signal before or after the detection of a bias signal, or establishing a reference signal before or after a predetermined number of bias signals have been received and processed.

The electronics preferably include a control circuit to operate a thermoelectric cooler/heater to adjust the temperature of the substrate 300 to produce optimum sensitivity.

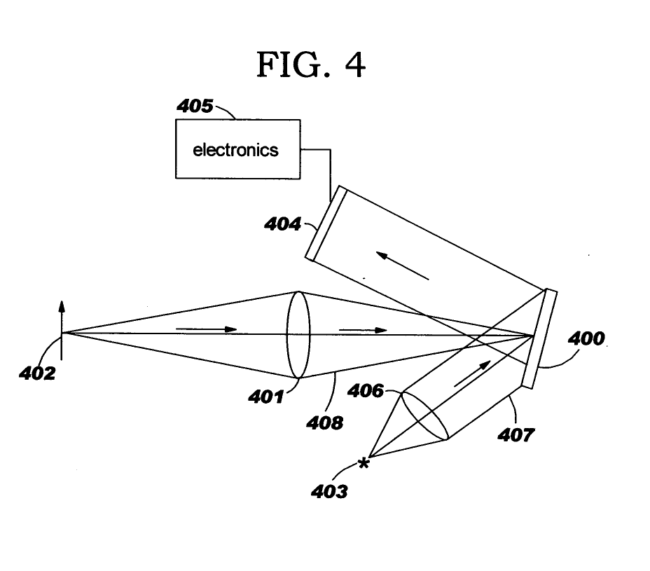

FIG. 4 shows an embodiment with a microplatform 400 which modulates the intensity of reflected high level incident radiation 407. This embodiment differs from the case of FIG. 3 which uses a microplatform to modulate the intensity of transmitted high level incident radiation. In the reflection configuration of FIG. 4 a high level visible or near infrared photonic source 403 is formed into a collimated or near collimated high level beam 407 by optics 406. The high level beam reflected from the microplatform 404 may also be focused onto the photodetector 404 with separate optics. The high level beam 407 is reflected from the microplatform or array of microplatforms 400 to terminate in the photodetector or array of photodetectors 404. The source of low level radiation 402 focussed by optics 401 onto the plane of the microplatform 400 thereby causing an incremental heating of the microplatform or array of microplatforms in correspondence to the cross section of the focused low level beam 408. The electronics 405 may be external from the photodetector 404 or may be integrated into the substrate of photodetector 404. The basic functions of the reflecting radiation sensor system of FIG. 4 are similar to that of the transmissive sensor system of FIG. 3 except that in the FIG. 4 case the high level beam 407 is reflected from the MOEMS microplatform plane.

One embodiment of the FIG. 4 configuration places the high level source 403 and the photodetector 404 within the area of the low level beam 408 thereby providing an approximately normally-incident high level and low level illumination of the microplatform. In this embodiment both the high level source 403 and the photodetector 404 partially shadow the incident low level radiation 408 onto the microplatform. This embodiment has the advantage of compactness and design simplicity.

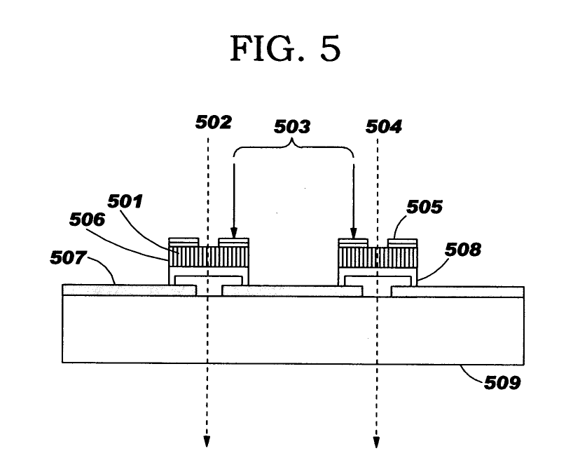

FIG. 5 shows an enlarged schematic representation of two microplatforms corresponding to elements in the MOEMS plane 300 of the transmissive embodiment. The incident high level beam 502 passes through the microplatform to terminate in the photodetector disposed in alignment and adjacent to the substrate 509. The microplatform consists of a base plane 506 and tether beam 508 providing a support and thermal isolation framework for the platform. Disposed on the base plane 506 is the pyro-optical film and resistive heater structures 501 which modulate the intensity of the carrier beam 502. The incident low level radiation 503 is partially absorbed in the microplatform causing the desired incremental heating effect for the platform or MOEMS pixel. A surface structure 505 can be added to the base plane 506 to increase absorption of the incident low level radiation beam 503. A patterned conductive film 507 selectively transmits the high level beam through to the photodetector. Patterned film 507 selects that portion of the beam which is modulated by the pyro-optic film and rejects that portion which is not modulated thereby improving the overall signal to noise ratio of the radiation sensor system. Film 507 also forms the electrical power supply for the heater element within each microplatform. The tetherbeams within 608 include the electrical interconnects to the underlying bus 507. The two microplatforms of FIG. 5 can be fabricated as a one or two dimensional array on substrate 509. Substrate 509 is optically transparent to the carrier beam 502.

The two example microplatforms in embodiment FIG. 5 are fabricated using micromachining technology involving patterned depositions and a sacrificial layer onto the substrate 509. The embodiment of FIG. 5 is fabricated on a quartz or other substrate 509 transparent to the high level carrier beam 502. An opaque metal 507 including aluminum is sputtered with a thickness of 100 nm or more and patterned onto the substrate 509. Next a sacrificial layer including polyimide is spun on and patterned to accommodate the anchors from the tether beams 508 of the microplatform plane 506. The microplatform plane 508 and tetherbeams are obtained by CVD deposition of silicon dioxide at low temperature with appropriate lithographic patterning. The base plane 506 is covered with a pyro-optical film and also appropriately patterned using lithography. Next vias are patterned into the sacrificial film to accomodate the electrical interconnect. Structure 506 contains the pyro-optical film formed and patterned from material selected from the group including vanadium oxide, aluminum gallium arsenide, indium gallium nitride, indium gallium arsenide, indium antimonide, antimony sulfoiodide, barium titanate, barium strontium titanatate, antimony sulphur iodide, and lead lanthanum zirconate titanate, and crystallites of various semiconductors. In this preferred embodiment the patterned pyro-optical film 506 also serves as the heating element. Next vias are etched with reactive ion etching through the tetherbeam structure in 508 to expose the surface of 507. This via is cut for the purpose of making the electrical connection to the power bus 507. The interconnect also within 501 from the heater element to the power bus 507 is now sputter deposited and patterned. Level 501 also contains the patterned metallic overlay of preferably a titanium-gold sandwich that forms the interconnect between the power bus 507 and the heating element 501. The pyro-optical material which is specifically selected to form film layer 501 will depend upon the wavelength of the high level radiation that is to be modulated, the response wavelength window of the photodetector, and the desired absorption of the low level beam 503 into film 501. A topmounted film or structure 505 to facilitate the absorption of low level radiation 503 may be deposited and patterned appropriately. The film 505 may be a carbon polymer or a structure with dipole resonance to absorb incident far infrared or millimeter wave radiation. The films 501 and 505 may be passivated with a protective film that is not attacked by the process step of removing the sacrificial film. The sacrificial film underlying the base plane 501 is removed at a processing step near the completion of processing. Polyimide is a compatible sacrificial layer for this embodiment and is removed using an oxygen plasma.

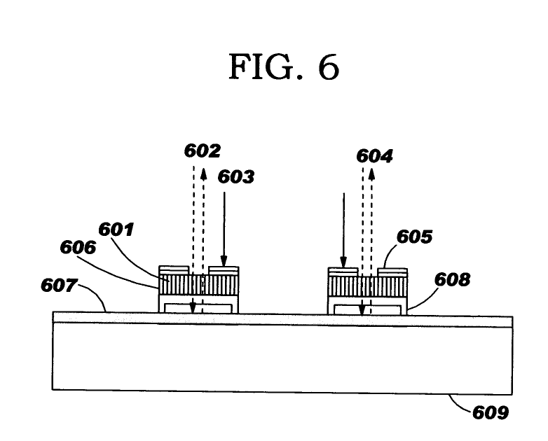

FIG. 6 describes the preferred embodiment of a radiation sensor MOEMS plane that modulates the reflected amplitude of high level carrier beam 602. The reflective microplatform schematic of two platforms in FIG. 6 is fabricated similarly to the embodiment of FIG. 5 except that the power bus contains two levels of conducting film 607, 619 and where film 607 also serves an optical reflector 607 for the high level carrier beam 602. The microplatform may be a single microplatform but is more typically an array of microplatforms that are mated to the reflective configuration of the photodetectors as illustrated in FIG. 4. The film 607 covering the substrate reflects the high level beam 602 which has a double-pass through the pyro-optical film 601. An additional modulation effect which increases the index of modulation is obtained with the double-pass of beam 602. The reflected beam 602 of FIG. 6 corrresponds to the source beam 407 modulated by the MOEMS plane 400 and exiting to the photodetector 404. The fabrication process for the reflective MOEMS plane of FIG. 6 is similar to that of the transmissive MOEMS plane of FIG. 5. The only basic difference is that the substrate 609 is typically silicon and is not transparent to the high level carrier beam as is the case in the FIG. 5 embodiment. Also the FIG. 6 embodiment contains an additional unpatterned conductive film 619 of sputtered aluminum. The film 607 forms the second power bus. Patterned vias in 608 provide the electrical connection for the sputtered interconnects on the microplatform 606 and into the respective underlying power bus lines. The power bus of FIG. 6 is shown to be driven from voltage sources as necessary for the heaters with a negative temperature coefficient of resistance.

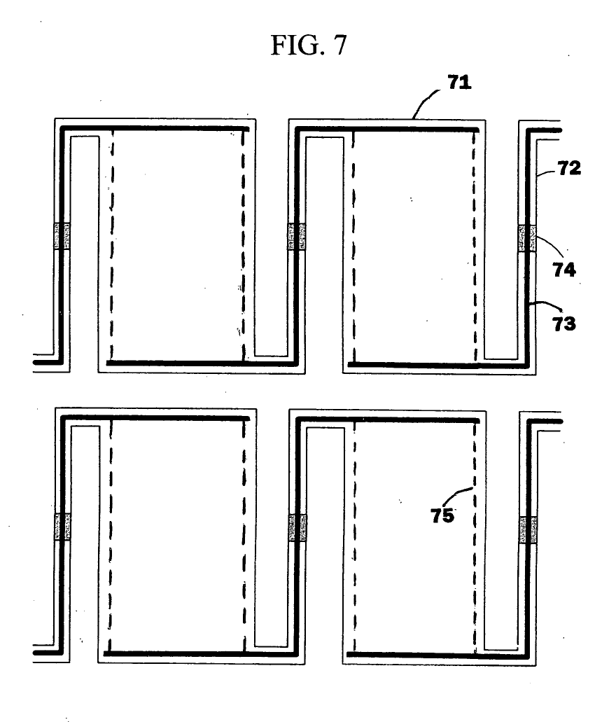

FIG. 7 is a schematic top view of a group of 4 arrayed microplatforms 71 showing the electrical interconnect 73 delivering electrical power to the vanadium oxide film heater 75. The tetherbeams 72 supporting each pixel contain the electrical interconnect 73 and are further electrically connected to the underlying power bus through vias 74. The patterned vanadium oxide 75 serves as both the pyro-optical modulating film and the electrical heater element. The pixel structure 71,72 corresponds to the microplatforms 506, 606 of FIGS. 5 and 6. The platforms 508 and 608 each contain the electrical interconnect to the power bus 507, 607 and 519, 619. The underlying power bus is configured to drive each pixel heater with a constant voltage source for the case of a vanadium oxide heater with negative temperature coefficient of resistance.

In another preferred embodiment the pyro-optical film is separate from the heater element. For instance, the heater element can be formed of a serpentine pattern of PECVD polysilicon or sputtered tantalum silicide. In this case, the pyro-optical film and the heater element are fabricated as separate structures within the microplatform. In this embodiment, each pixel heater is connected in series and the entire array of microplatforms is driven from a constant current source to achieve the desired electro-thermal gain.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A radiation sensor comprising:
a microplatform including an integral pyro-optical film positioned above and thermally isolated from a substrate;
a resistive heater element integral to the microplatform and powered from a fixed amplitude source to increase the temperature to a quiescent level above that of the substrate;
a first source of low level radiation incident upon the microplatform and partially absorbed causing a first incremental heating of said microplatform;
wherein the first incremental heating causes a change in the electrical resistance of said heater and a corresponding second incremental heating thereby providing a total incremental heating in excess of the first incremental heating;
a second beam source of photonic radiation incident on and exiting from said film with the amplitude of the exiting photonic beam modulated by the temperature of said film;
and a detector monitoring the intensity of said second beam exiting the sensor platform thereby providing an output signal measurement representative of the amount of low level radiation incident on the sensor and enhanced by the second incremental heating thereby providing a means of electro-thermal gain.

2. The radiation sensor of claim 1 where the heater element exhibits a negative temperature coefficient of resistance and is powered from a voltage source.

3. The radiation sensor of claim 1 where the heater element exhibits a positive temperature coefficient of resistance and is powered from an electrical current source.

4. The radiation sensor of claim 1 where the detector is formed within said substrate.

5. The radiation sensor of claim 1 where said first and second source of radiation may be derived from a larger number of sources.

6. The radiation sensor of claim 1 operated in a vacuum for the purpose of increasing thermal isolation of the microplatform from said substrate.

7. The radiation sensor of claim 1 where the exiting beam of the second source of radiation is reflected from or transmitted through said pyro-optical film.

8. The radiation sensor of claim 1 where the first source of radiation is low level within bandwidths ranging from ultraviolet to the far infrared or millimeter wavelengths.

9. The radiation sensor of claim 1 configured in an array of pixels and imaged to a detector comprised of a charge-coupled-diode or CMOS imager array with signal conditioning circuitry configured to output an electrical signal formatted for driving external image displays or databases.

10. The radiation sensor of claim 1 where the pyro-optical film is comprised of an oxide of vanadium maintained at a quiescent temperature ranging from 50 deg to 70 deg Centigrade.

11. The radiation sensor of claim 1 where the pyro-optical film is comprised of a semiconductor or liquid crystal material in which absorption of the first radiation source increases with temperature.

12. The radiation sensor of claim 1 disposed in the form of an array physically aligned over a matching array of detectors comprised of charge-coupled diodes, a CMOS imager, or a thermal imager, each sensitive to a wavelength component of the second radiation source.

13. The radiation sensor of claim 1 where the second radiation source is an ultraviolet, visible, or near infrared light source comprised of a light emitting diode, incandescent source, or a laser source.

14. The configuration of claim 13, where the second radiation source is disposed immediately adjacent to the microplatform to project radiation into the microplatform.

15. The radiation sensor of claim 1 where the low level radiation source is a radiation-emitting chemical reaction or biological process including chemiluminescence and bioluminescence.

16. The radiation sensor of claim 1 comprised of an array of microplatform pixels and mating detector pixels.

17. A thermal imaging system for producing an image of a scene in response to incident infrared radiation from said scene, comprising:
a microplatform array with each microplatform containing an integral pyro-optical film positioned above and thermally isolated from a substrate;
optics for focusing low level incident infrared radiation emitted by the scene onto the array causing a first incremental heating of the microplatform elements;
a chopper for the incident infrared radiation disposed between the optics and the microplatform array;
a resistive heater element within each microplatform powered from a constant amplitude source to raise the temperature of each microplatform to a quiescent level with respect to the substrate;
wherein the first incremental heating causes change in the electrical resistance of said heater and a corresponding second incremental heating;
a detector with a plurality of photosensor pixels aligned with corresponding pixels of the microplatform array;
a light source disposed adjacent to the microplatform array to project a second source of radiation through the microplatform array onto the detector for the purpose of transferring thermal-images formed on the microplatform array to the associated photosensor pixels;
said microplatform array and the photosensors cooperating with the chopper and the light source to produce a biased signal and a reference signal;
electronics for receiving the biased signal and the reference signal and for subtracting the reference signal from the biased signal to obtain an unbiased signal representing radiance differences emitted by objects in the scene thereby providing an output signal measurement representative of the amount of low level radiation incident on the sensor and enhanced by the second incremental heating thereby providing a means of electro-thermal gain.

18. The system of claim 17 wherein each microplatform pixel further comprises the microstructures:
a plurality of posts mounted on the substrate;
each post or plurality of posts attached to a structural arm for the purpose of supporting a microplatform;
and where the posts cooperate with the respective arms to form a gap between the microplatform and the substrate equal to approximately one-quarter of a wavelength of the incident low level radiation.

19. The system of claim 17 wherein the second source projects electromagnetic radiation from portions of the ultraviolet, visible and the near infrared spectrum.

20. The system of claim 17 where the pyro-optical film is formed from vanadium oxide maintained at a quiescent temperature between 40 and 70 degrees Centigrade.

21. The system of claim 17 where the pyro-optical film is formed from material selected from the group consisting of gallium arsenide phosphide, gallium aluminum nitride, indium gallium arsenide, antimony sulfoiodide, barium titanate, barium strontium titanate, antimony sulphur iodide, and lead lanthanum zirconate titanate.
